(19) United States
(12) Patent Application Publication
(10) Pub. No.: US 2002/0023667 A1
(43) Pub. Date: Feb. 28, 2002

(54) Apparatus and method for cleaning a probe tip

(76) Inventor: Thuan Pham, Rocky Mount, NC (US)

Correspondence Address: Brad A. Schepers, Esq., Woodard, Emhardt, Naughton, Moriarty and McNett, Bank One Center/Tower, 111 Monument Circle, Suite 3700, Indianapolis, IN, 46204-5137, US

(21) Appl. No.: 09/942,317

(22) Filed: Aug. 29, 2001

Related U.S. Application Data
(60) Provisional application No. 60/229,279, filed on Aug. 31, 2000.

(51) Int. Cl. B08B 3/02

(52) U.S. Cl. 134/18; 134/36; 134/102.1; 134/57 R; 134/199

(57) ABSTRACT

An apparatus and method for removing contaminants from the probe tip of a coordinate measurement machine. The apparatus includes a cleaning chamber and a number of spray nozzles arranged to direct a cleaning solution onto the probe tip from multiple directions. The spray nozzles are adjustable to vary the distance between the head of each nozzle and the probe tip. A photoelectric sensor is provided to detect the presence of the probe tip within the cleaning chamber. A control valve is opened in response to detection of the probe tip to selectively deliver a cleaning fluid to the spray nozzles. A timer selectively controls the commencement and/or the duration of the spray cycle. The cleaning solution preferably comprises a mixture of compressed air and isopropyl alcohol, intermixed by a fluidic mixer. The mixer is preferably adjustable to regulate the amount of isopropyl alcohol intermixed with the compressed air.

### CROSS REFERENCE TO RELATED APPLICATIONS

The present application claims the benefit of Provisional Application Ser. No. 60/229,279, filed Aug. 31, 2000 and entitled Apparatus and Method for Cleaning a Probe Tip, the contents of which are hereby incorporated by reference in their entirety.

### BACKGROUND OF THE INVENTION

The present invention relates generally to a parts cleaning system. More specifically, but not exclusively, the present invention relates to an apparatus and method for cleaning a probe tip, and more particularly a probe tip for use in association with a coordinate measurement machine.

Coordinate measurement machines (CMMs) are programmable measuring instruments that are used to accurately collect and report dimensional data for virtually any type of manufactured product or workpiece. CMMs typically collect dimensional data by placing the tip of a calibrated probe into direct contact with a touch point, such as a surface or edge of the product or workpiece to be measured. The CMM records the locations of these touch points and generates a database reflecting the precise dimensional and geometric features of the workpiece. During the measuring process, the probe tip has a tendency to collect dirt, oil and other contaminants from the workpiece and the surrounding environment. If the probe tips are left uncleaned, the accuracy and reliability of the measurement data generated by the CMM may be negatively affected.

Currently, probe tips are manually cleaned by the operator of the CMM or by a maintenance worker. Typically, a liquid cleaner and a cloth or tissue are used to wipe the outer surface of the probe tip to remove any accumulated contaminants. However, this method of cleaning presents several drawbacks. For example, cleaning the probe tip by hand is time and labor intensive, thereby resulting in increased maintenance costs and machine downtime. As a result, the probe tip is usually cleaned at sporadic and/or infrequent intervals, typically during periods of non-production and usually only once per day. In order to ensure the accuracy and reliability of the measurement data generated by the CMM, the probe tip should be frequently cleaned at predetermined and periodic intervals. Preferably, the probe tip should be cleaned after the measurement of each product or workpiece, and in extreme cases, after each and every measurement. Additionally, as is true with virtually any manual operation, cleaning the probe tip by hand may not be totally reliable or effective, as there is always the possibility that the probe tip will remain uncleaned or will be inadequately cleaned.

Heretofore, there has been a need for an apparatus and method for cleaning the probe tip of a coordinate measurement machine which addresses some or all of the drawbacks discussed above with regard to current cleaning methods. An effective means for satisfying this need has escaped those skilled in the art. The present invention satisfies this need in a novel and unobvious way.

### SUMMARY OF THE INVENTION

In one form of the present invention, an apparatus for cleaning a part is provided, comprising a cleaning chamber, at least one nozzle arranged to direct a cleaning fluid onto at least a portion of the part, a sensor adapted to detect the presence of the part and to generate a control signal in response thereto, and a valve adapted to open in response to the control signal to deliver the cleaning fluid to the nozzle.

In another form of the present invention, an apparatus for cleaning a part is provided, comprising a cleaning chamber, a mixer adapted to intermix a cleaning agent with a compressed fluid to form a cleaning solution, at least one nozzle arranged to direct the cleaning solution onto at least a portion of the part disposed within the cleaning chamber, and a valve adapted to selectively deliver the cleaning solution to the nozzle.

In a further form of the present invention, an apparatus for cleaning a part is provided, comprising a cleaning chamber, means for mixing a compressed fluid and a cleaning agent to form a cleaning solution, means for sensing a presence of the part within the cleaning chamber, and means for spraying the cleaning solution onto at least a portion of the part in response to sensing the presence of the part within the cleaning chamber.

In still another form of the present invention, a method of cleaning a probe tip is provided, comprising providing a cleaning chamber and at least one nozzle, positioning the probe tip within the cleaning chamber, mixing a compressed fluid with a cleaning agent to form a cleaning solution, detecting the presence of the probe tip, and dispensing the cleaning solution from the nozzle and onto at least a portion of the probe tip in response to the detection of the probe tip.

In still a further form of the present invention, a method of cleaning a probe tip is provided, comprising providing a cleaning chamber, a cleaning agent contained within the cleaning chamber, and at least one nozzle adapted to dispense a fluid, submerging the probe tip in the cleaning agent, positioning the probe tip adjacent the at least one nozzle, and dispensing the fluid from the at least one nozzle and onto the probe tip.

One object of the present invention is to provide an improved apparatus and method for cleaning a probe tip.

Related objects and advantages of the present invention will become apparent from the following description and illustrations.

### BRIEF DESCRIPTION OF THE DRAWINGS

FIG. 1 is a side perspective view of an automatic probe tip cleaner according to one form of the present invention.

FIG. 2 is a front elevational view of the automatic probe tip cleaner shown in FIG. 1, with the cover enclosing the electronic controls being removed for clarity.

FIG. 3 is a top plan view of the automatic probe tip cleaner shown in FIG. 2.

FIG. 4 is a block diagram of the electronic and fluidic circuits for the automatic probe tip cleaner shown in FIGS. 1-3.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended, such alterations and further modifications in the illustrated apparatus and method, and such further applications of the principles of the present invention as illustrated herein being contemplated as would normally occur to one skilled in the art to which the invention relates.

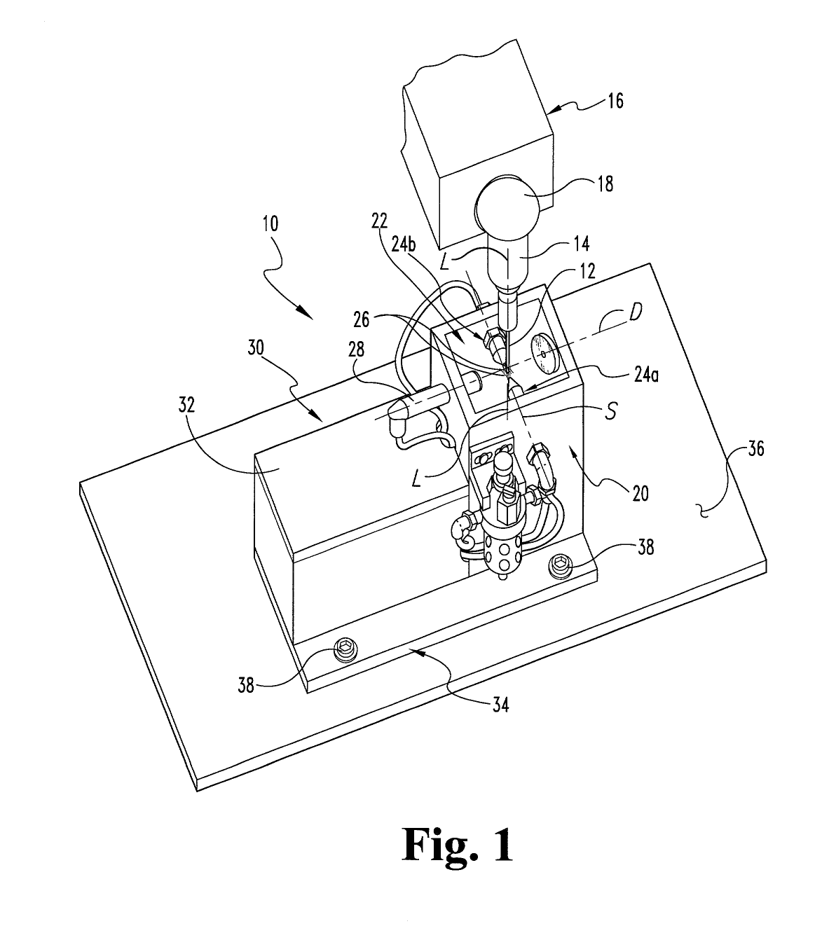

Referring to FIG. 1, there is illustrated an automatic probe tip cleaner 10 according to one form of the present invention. The automatic probe tip cleaner 10 operates to remove contaminants, such as dirt, oil, grease or the like, from the tip 12 of a probe 14 used in association with a coordinate measurement machine (CMM) 16. The CMM 16 is adapted to measure dimensional and geometric features of various workpieces, such as, for example, engine blocks or other engine components (not shown), by placing the probe tip 12 into direct contact with the workpiece to be measured. As a result of this direct contact, contaminants have a tendency to accumulate on the outer surface of the probe tip 12. Such contaminants must be periodically removed from the probe tip 12 to maintain the accuracy and reliability of the measurement data generated by the CMM 16.

One example of a CMM 16 that may be used in association with the present invention is manufactured by LK Metrology Systems, Inc. of Brighton, Michigan under Model No. IIC-90. The CMM 16 is a multi-axis machine and is equipped with a rotating head 18 adapted to displace the probe 14 throughout an infinite number of positions and orientations relative to the product or workpiece being measured. However, it should be understood that the present invention is suitable for use with other types and configurations of probe tips and coordinate measurement machines. It should further be understood that application of the present invention is not intended to be limited to the cleaning of CMM probe tips, but is equally suited to clean other types of parts in various cleaning applications as would occur to one of ordinary skill in the art.

The probe tip cleaner 10 generally comprises a housing 20 defining a cleaning chamber 22 extending along a longitudinal cleaning axis L, and a pair of nozzles 24a, 24b arranged to direct a cleaning fluid 26 into the cleaning chamber 22 and onto the probe tip 12 disposed therein. Preferably, the nozzles 24a, 24b are arranged in an opposing fashion along a spray axis S, and are preferably spaced an equal distance from the longitudinal cleaning axis L. In one form of the invention, the spray axis S is oriented substantially perpendicular to the cleaning axis L. Although a pair of nozzles 24a, 24b is depicted in the illustrated embodiment, it should be understood that any number of nozzles could be used to clean the probe tip 12, including a single nozzle. Additionally, although a specific arrangement, position, and orientation of nozzles 24a, 24b has been illustrated and described, it should be understood that other arrangements, positions and orientations of nozzles 24a, 24b are also contemplated as falling within the scope of the present invention.

In one form of the invention, the cleaning fluid 26 is comprised of a mixture of a compressed fluid and a cleaning agent. In one specific embodiment, the compressed fluid is air. In another specific embodiment, the cleaning agent is an alcohol, such as, for example, isopropyl alcohol. However, it should be understood that other cleaning fluids are also contemplated for use with the present invention as would occur to one of ordinary skill in the art. For example, a compressed fluid, such as air or a cleaning agent could be used either alone or in succession to clean the probe tip 12.

In one form of the present invention, a sensor 28 is adapted to detect the presence of the probe tip 12 within the cleaning chamber 22. In response to the detection of probe tip 12, the cleaning fluid 26 is selectively delivered to the nozzles 24a, 24b and directed onto the outer surface of the probe tip 12, the details of which will be described below. The probe tip cleaner 10 preferably includes a controls compartment 30 that contains various electrical components (not shown in FIG. 1) used to automatically control the commencement and duration of the delivery of the cleaning fluid 26 to nozzles 24a, 24b. In one embodiment, the controls compartment 30 includes a cover 32 that may be removed to provide access to the electrical components or other components of the probe tip cleaner 10. The housing 20 and the controls compartment 30 are preferably attached to a base plate 34, which in turn is mounted to a work surface 36 by a number of fasteners 38. In one form of the invention, the work surface 36 is a granite table top of a type typically used in conjunction with coordinate measurement machines. The probe tip cleaner 10 is preferably positioned at a location free of obstructions, within easy reach of the CMM 16, and readily accessible by the CMM operator and/or a maintenance worker.

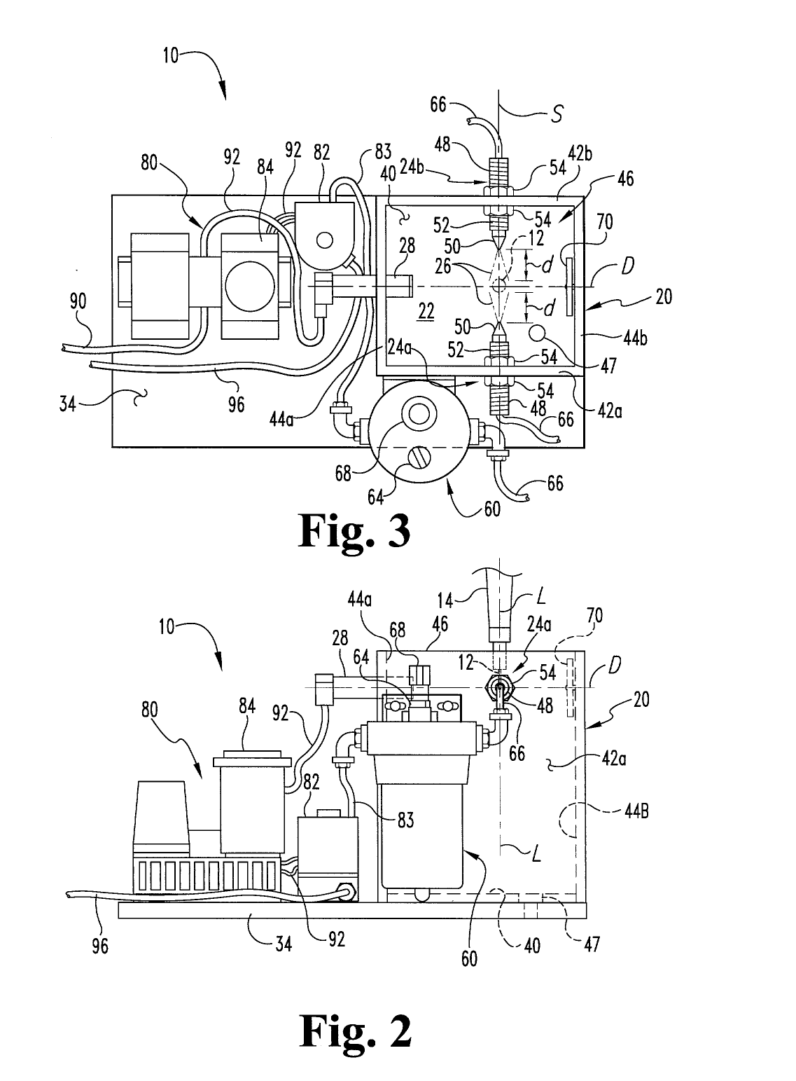

Referring to FIGS. 2 and 3, there are illustrated further details regarding probe tip cleaner 10. In one embodiment, the housing 20 is a box-like structure having a bottom 40, first and second pairs of spaced apart side walls 42a, 42b and 44a, 44b, and an open top 46. In one embodiment, housing 20 is formed of a corrosion-resistant material, such as, for example, aluminum. However, it should be understood that other materials are also contemplated, such as, for example, steel, stainless steel, a polymer, or a composite material. Although housing 20 is illustrated as having a generally square cross section, it should be understood that other configurations of housing 20 are also contemplated as would occur to one of ordinary skill in the art, such as, for example, a cylindrical or rectangular configuration. In an alternative embodiment, housing 20 may include a lid (not shown) adapted to be placed over the open top 46 to further contain the cleaning fluid 26 within the cleaning chamber 22. In this embodiment, the lid would include an access opening sized to receive the probe 14 therethrough to provide access to the cleaning chamber 22.

In one form of the present invention, the nozzles 24a, 24b extend through and are mounted to the first pair of opposing side walls 42a, 42b, respectively. In this particular arrangement, the nozzles 24a, 24b are capable of directing cleaning fluid 26 onto the probe tip 12 from generally opposite directions, thereby providing sufficient cleaning of the entire probe tip 12. However, as discussed above, it should be understood that any number of nozzles may be provided and arranged to direct cleaning fluid 26 onto the probe tip 12 from any direction. The bottom 40 of the housing 20 preferably includes an opening 47 adapted to collect the over-spray of cleaning fluid 26 and the contaminants removed from the probe tip 12. In one embodiment, a cloth (not shown), such as a shop towel, may be disposed within the opening 47 to capture or absorb the over-spray and contaminants. The cloth should be periodically replaced, preferably on a daily basis. In another embodiment, the opening 47 could be placed in fluid communication with a waste recovery station via a drain pipe or tube (not shown).

Each nozzle 24a, 24b includes a body 48 which extends through a corresponding opening in the housing 20, and a spray head 50 disposed within the cleaning chamber 22. Spray head 50 is configured to spray cleaning fluid 26 onto the probe tip 12, preferably in a relatively tight or narrow spray pattern so as to minimize the amount of cleaning fluid 26 necessary to effectively and efficiently clean the probe tip 12. An example of a spray nozzle suitable for use with the present invention is manufactured by Nycoil of Fanwood, N.J. under Part No. 32-99031. However, other suitable nozzles are also contemplated as would occur to one of ordinary skill in the art.

In one form of the present invention, the position of nozzles 24a, 24b is adjustable relative to the housing 20 generally along the spray axis S to allow a distance d between the spray head 50 and the probe tip 12 to be selectively varied. In one specific embodiment, the body 48 has a cylindrical shape and includes a series of outer threads 52. Nuts 54 are threaded onto the cylindrical body 48, positioned on each side of side wall 42a, 42b and tightened to secure the nozzles 24a, 24b to housing 20. The distance d between the spray head 50 and the probe tip 12 may be adjusted by loosening nuts 54, repositioning the nozzle 24a, 24b into a desired position along the spray axis S, and retightening nuts 54. It should be understood that other methods for adjusting the distance d are also contemplated as would occur to one of ordinary skill in the art.

In one form of the present invention, a fluidic mixer 60 is provided to produce the cleaning fluid 26. In the illustrated embodiment, the mixer 60 is mounted to side wall 42a of housing 20; however, other mounting arrangements are also contemplated as would occur to one of ordinary skill in the art. As mentioned above, in one specific embodiment, the cleaning fluid 26 is a cleaning solution mixture comprised of compressed air and isopropyl alcohol. The isopropyl alcohol is contained within a reservoir (not shown) in mixer 60 which may be refilled as required by removing a fill cap 64. The mixer 60 releases the isopropyl alcohol in a controlled manner and intermixes the alcohol with compressed air to form the cleaning solution 26. The cleaning solution 26 is delivered to each of the spray nozzles 24a, 24b through conduits 66. In one form of the present invention, the conduits 66 are tubes formed of materials such as, but not limited to, steel, cooper, plastic or other suitable materials known to those of ordinary skill in the art. The mixer 60 is preferably equipped with an adjustment handle 68 which selectively controls the amount of isopropyl alcohol to be intermixed with the compressed air to thereby control the compositional makeup of the cleaning solution 26. An example of a fluidic mixer 60 suitable for use with the present invention is manufactured by Rexroth of Lexington, Kentucky under Part No. PG7900. However, other suitable types of mixing devices are also contemplated as would occur to one of ordinary skill in the art.

As discussed above, the sensor 28 is adapted to detect the presence of the probe tip 12 within the cleaning chamber 22. However, it should be understood that the sensor 28 could alternatively be configured to detect the presence of other portions of the probe 14 or the CMM 16, either within or outside of the cleaning chamber 22. In one specific embodiment of the present invention, the sensor 28 is an optical sensor including an emitter for emitting a photoelectric beam and a receiver for correspondingly receiving the photoelectric beam. In the illustrated embodiment, the emitter and the receiver are combined into a single unit that extends through and is mounted to the side wall 44a of housing 20. An example of an optical sensor suitable for use with the present invention is manufactured by Efector, Inc. of Exton, Pennsylvania under Part No. OG0033 OGP-DBAOA/LS. However, it should be understood that other suitable sensors are also contemplated as would occur to one of ordinary skill in the art, such as, for example, a proximity switch, a mechanical limit switch, or any other type of sensor that is capable of detecting the presence of probe tip 12 or another portion of CMM 16.

The photoelectric beam emitted by the emitter is reflected 180 degrees back to the receiver by an optical reflector 70 positioned generally opposite sensor 28 and mounted to the interior of side wall 44b. In this manner, the photoelectric beam extends across a substantial portion of the cleaning chamber 22, generally along a detection axis D. In one form of the invention, the detection axis D is substantially perpendicular to and co-planar with the spray axis S. However, other positions and orientations of detection axis D are also contemplated.

In operation, when the probe tip 12 requires cleaning, the CMM 16 is programmed to position the probe tip 12 in a predetermined position relative to the probe tip cleaner 10, preferably being displaced through a travel path extending generally along the cleaning axis L. The probe 14 extends through the open top 46 of housing 20, with the probe tip 12 being disposed within the cleaning chamber 22 at a general location where the detection axis D and the spray axis S intersect. As a result, the presence of the probe tip 12 breaks the photoelectric beam and the sensor 28 generates a control signal corresponding to the presence of the probe tip 12 within the cleaning chamber 22. The control signal generated by sensor 28 is received by a controller 80 which responds by opening a control valve 82 to supply compressed air to the mixer 60 and to correspondingly deliver the cleaning solution 26 to the nozzles 24a, 24b. The compressed air is delivered to the mixer 60 through a conduit 83, which may be formed of the same material as conduits 66.

In one form of the present invention, the controller 80 includes a timer 84 configured to control the operation of the control valve 82. The timer 84 may be set to selectively control the commencement and/or duration of the delivery of the cleaning solution 26 to the spray nozzles 24a, 24b. In one specific embodiment, the duration of the spray cycle is between about one (1) second and about three (3) seconds. However, it should be understood that other spray cycles are also contemplated depending upon the particular application and cleaning requirement of the probe tip cleaner 10. In one form of the present invention, the timer 84 may be set to operate in various operational modes. For example, in “OS” mode, the timer 84 will open the control valve 82 in response to the activation of sensor 28 (i.e., when sensor 28 detects the presence of probe tip 12), and will close the control valve 82 after the passage of a set period of time. In “PO” mode, the timer 84 will open the control valve 82 following the passage of a set period of time after the sensor 28 is activated, and will close the control valve 82 when the sensor 28 is deactivated (i.e., when sensor 28 no longer detects the presence of probe tip 12). In “SF” mode, the timer 84 will open the control valve 82 in response to activation of the sensor 28, and will close the control valve 82 after the passage of a set period of time following deactivation of the sensor 28. The above-discussed operational modes of the timer 84 are exemplary and are not intended to be limiting in nature, it being understood that other operational modes of the probe tip cleaner 10 are also contemplated as being within the scope of the invention.

An example of a controller 80 suitable for use with the present invention is manufactured by Allen-Bradley of Greenville, S.C. under Part No. 700-HA33A1. An example of a control valve 82 suitable for use with the present invention is manufactured by Parker Hannifin Corporation of Madison, Miss. under Part No. 04F20C2110ACFGC05. An example of a timer 84 suitable for use with the present invention is manufactured by Allen-Bradley of Greenville, S.C. under Part No. 700-HR52TA17. However, it should be understood that other suitable controllers, timers and control valves are also contemplated as would occur to one of ordinary skill in the art. Additionally, although the controller 80, control valve 82, and timer 84 have been illustrated and described as being mounted to base plate 34 and disposed within the controls compartment 30, it should be understood that these electrical components could alternatively be disposed at a location remote from housing 20, such as, for example, within a remote electrical control panel. It should also be understood that the sensor 28, controller 80, and timer 84 could be eliminated, and operation of the probe tip cleaner 10 could be controlled manually, such as by the operator of the CMM 16. It should further be understood that the operations performed by the sensor 28, controller 80, and timer 84 could alternatively be performed by another device, such as, for example, the CMM controller.

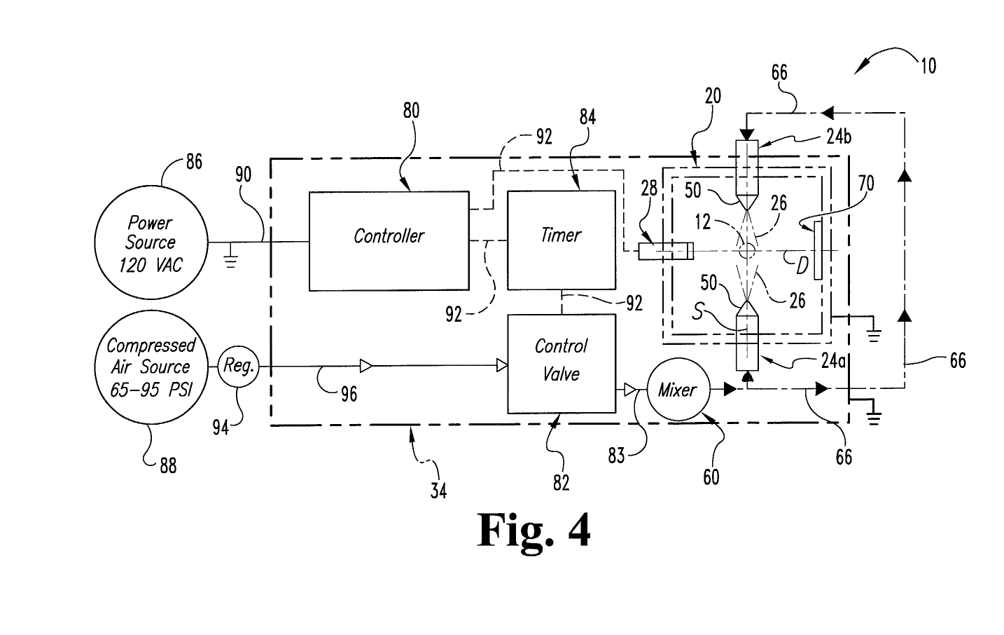

Referring to FIG. 4, there is illustrated a block diagram of the electronic and fluidic circuits associated with the probe tip cleaner 10. In one form of the present invention, the probe tip cleaner 10 is powered by a remote electrical power source 86, preferably adapted to supply the probe tip cleaner 10 with 120VAC power. The probe tip cleaner 10 is also supplied with compressed air from a remote air source 88. In one embodiment of the invention, a regulator or flow control device 94 is provided to regulate the pressure of the compressed air supplied to the probe tip cleaner 10, preferably within a pressure range of about 65 psi to about 95 psi. In an alternative embodiment, the control valve 82 could include an adjustment means to selectively control the quantity of compressed air supplied to the mixer 60 when the control valve 82 is opened. An example of a regulator 94 suitable for use with the present invention is manufactured by Schrader of Akron, Ohio under Part No. 00337-1001. However, it should be understood that other suitable flow control devices are also contemplated as would occur to one of ordinary skill in the art. It should also be understood that the regulator 94 could be disposed at a location remote from the probe tip cleaner 10, or could be mounted directly to the base plate 34, either inside or outside of the controls compartment 30.

Power is supplied to the controller 80 by an electrical cable 90, which is preferably grounded to reduce the likelihood of the generation of an arc or spark which could potentially serve as a vapor ignition source. The sensor 28, control valve 82 and timer 84 are electrically coupled by wiring or cabling 92, or by any other method as would occur to one of ordinary skill in the art. Compressed air is supplied to the control valve 82 by conduit 96, which is preferably formed of a non-conductive material, such as, for example, polyethylene, to reduce the likelihood of electrical current being transferred to the probe tip cleaner 10 from an external ignition source. Additionally, the housing 20 and/or the base plate 34 is preferably electrically grounded to reduce the likelihood of the generation of an arc or spark. It should be understood that various electrical connectors and air/fluid fittings are required to complete the illustrated electronic and fluidic circuits, the details of which would be apparent to one of ordinary skill in the art.

Following is a description of the cleaning cycle of the probe tip cleaner 10 according to one form of the present invention. The CMM 16 is programmed to position the probe tip 12 within the cleaning chamber 22 by inserting the probe 14 through the open top 46 of housing 28, preferably being displaced through a travel path extending generally along axis L. The probe tip 12 intersects the detection axis D, thereby breaking the photoelectric beam of the sensor 28. The activation of the sensor 28 generates a control signal which is received by the controller 80. The controller 80 responds by opening the control valve 82 to supply compressed air to the mixer 60. The mixer 60 intermixes a controlled amount of isopropyl alcohol with the compressed air stream to form the cleaning solution 26. The cleaning solution 26 is delivered to each of the opposing nozzles 24a, 24b and is sprayed onto the probe tip 12. The control valve 82 is closed after a predetermined period of time or in response to deactivation of the sensor 28, or a combination of both. The timer 84 can be adjustably set to control the commencement and/or duration of the spray cycle. The position of the nozzles 24a, 24b is also adjustable to vary the distance d between the spray heads 52 and the probe tip 12.

The above-described cleaning cycle of the probe tip cleaner 10 is repeated as required by the particular application. In one form of the present invention, the cleaning cycle is executed prior to the measurement or inspection of each product or workpiece. However, it should be understood that the probe tip 12 could be cleaned at either more frequent or less frequent intervals depending upon the particular application and cleaning requirement of the probe tip cleaner 10. For example, in cases where contaminants have a tendency to rapidly accumulate on probe tip 12, the probe tip 12 may requiring cleaning several times during the measurement of a workpiece, which in extreme cases may be after each measurement of the workpiece. However, in cases where the probe tip 12 is not prone to accumulating a large amount of contaminants, the probe tip 12 may only require cleaning subsequent to the measurement or inspection of several workpieces.

In another form of the present invention, the mixer 60 is eliminated from the fluidic circuit and the cleaning chamber 22 is partially filled with a cleaning fluid, preferably to a level somewhat below the height of the nozzles 24a, 24b and the spray axis S. In one form of the invention, the cleaning fluid is somewhat volatile such that it will have a tendency to evaporate from the surface of the probe tip 12 in a relatively short period of time. An example of a suitable cleaning fluid is alcohol, such as, for example, isopropyl alcohol. However, other cleaning fluids or solutions are also contemplated as would occur to one of ordinary skill in the art.

The CMM 16 is preferably programmed to position the probe 14 within the cleaning chamber 22 and to completely submerge the probe tip 12 within the cleaning fluid. The CMM 16 then withdraws the probe tip 12 from the cleaning solution and positions the probe tip 12 along the spray axis S. The control valve 82 is then opened to supply compressed air to the opposing nozzles 24a, 24b. The compressed air is blown onto the probe tip 12 to remove any remaining contaminants and/or any residual cleaning fluid. In this manner, the compressed air also serves as a type of cleaning fluid. Blowing compressed air onto the probe tip 12 also facilitates or speeds up evaporation of any cleaning fluid remaining on the surface of the probe tip 12.

In this alternative form of the invention, the timer 84 is preferably set in the “PO” mode such that the control valve 82 will open following the passage of a set period of time after the sensor 28 is activated (i.e., when sensor 28 detects the presence of probe tip 12), and will close when the sensor 28 is deactivated (i.e., when sensor 28 no longer detects the presence of probe tip 12). The delay period between the activation of the sensor 28 and the opening of the control valve 82 is preferably set to correspond to the amount of time the probe tip 12 must remain submerged within the cleaning fluid to ensure adequate cleaning. The period of time that the control valve 82 remains open is preferably set to correspond to the amount of time necessary to adequately dry the probe tip 12. However, as discussed above, it should be understood that other operational modes of the probe tip cleaner 10 are also contemplated as being within the scope of the invention. In a further embodiment of the present invention, the cleaning fluid may be heated to facilitate cleaning of the probe tip and to further enhance evaporation of residual cleaning fluid from the outer surface of the probe tip 12.

While the present invention has been illustrated and described in detail in the drawings and foregoing description, the same is to be considered as illustrative and not restrictive in character, it being understood that only the preferred embodiments have been shown and described, and that all changes and modifications that come within the spirit of the invention are desired to be protected.

What is claimed is:

1. An apparatus for cleaning a part, comprising:
a housing defining a cleaning chamber;
at least one nozzle adapted to direct a cleaning fluid onto at least a portion of the part disposed within said cleaning chamber;
a sensor adapted to detect a presence of the part and to generate a control signal in response thereto; and
a valve adapted to open in response to said control signal to deliver said cleaning fluid to said at least one nozzle and to dispense said cleaning fluid onto said at least a portion of the part.

2. The apparatus of claim 1 further comprising a timer adapted to close said valve after passage of a predetermined period of time following generation of said control signal.

3. The apparatus of claim 1 further comprising a timer adapted to close said valve after passage of a predetermined period of time following removal of said control signal.

4. The apparatus of claim 1 further comprising a timer adapted to open said valve after passage of a predetermined period of time following generation of said control signal to deliver said cleaning fluid to said at least one nozzle.

5. The apparatus of claim 1 wherein said valve opens in response to generation of said control signal.

6. The apparatus of claim 1 wherein said valve closes in response to removal of said control signal.

7. The apparatus of claim 1 further comprising a plurality of said at least one nozzle, said plurality of nozzles being arranged to direct said cleaning fluid onto said at least a portion of the part from a plurality of directions.

8. The apparatus of claim 1 further comprising an opposing pair of said at least one nozzle, said opposing pair of nozzles being arranged to direct said cleaning fluid onto said at least a portion of the part from generally opposite directions.

9. The apparatus of claim 1 wherein said at least one nozzle is a spray nozzle having a spray head, said at least one nozzle extending through said housing with said spray head being disposed within said cleaning chamber, said spray head being adapted to spray said cleaning fluid onto said at least a portion of the part.

10. The apparatus of claim 9 wherein said at least one nozzle is adjustable to vary a distance between said spray head and said at least a portion of the part.

11. The apparatus of claim 1 wherein said sensor is an optical sensor, said optical sensor including an emitter adapted to emit a photoelectric beam and a receiver adapted to receive said photoelectric beam, said presence of said at least a portion of the part breaking said photoelectric beam, said optical sensor generating said control signal in response to said breaking of said photoelectric beam.

12. The apparatus of claim 11 wherein said photoelectric beam extends along a first axis, said at least one nozzle being arranged to direct said cleaning fluid generally along a second axis, said first axis and said second axis being substantially co-planar.

13. The apparatus of claim 1 further comprising a mixer, said valve being adapted to supply a compressed fluid to said mixer in response to said control signal, said mixer being adapted to intermix a cleaning agent with said compressed fluid to form said cleaning fluid.

14. The apparatus of claim 13 wherein said mixer is adapted to selectively control an amount of said cleaning agent to be intermixed with said compressed fluid.

15. The apparatus of claim 13 further comprising a regulator adapted to regulate delivery of said compressed fluid to said mixer.

16. The apparatus of claim 1 wherein said housing includes an opening in communication with said cleaning chamber, the part extending through said opening with said at least a portion of the part being disposed within said cleaning chamber.

17. The apparatus of claim 1 wherein the part is a measurement probe used in association with a coordinate measurement machine, said at least a portion of the part comprising a tip of said measurement probe.

18. The apparatus of claim 1 wherein said cleaning fluid is a cleaning solution, said cleaning solution being comprised of a compressed fluid and a cleaning agent.

19. The apparatus of claim 18 wherein said compressed fluid is air and wherein said cleaning agent is isopropyl alcohol.

20. The apparatus of claim 18 wherein said cleaning fluid is compressed air.

21. An apparatus for cleaning a part, comprising:
a housing defining a cleaning chamber;
a mixer adapted to intermix a cleaning agent with a compressed fluid to form a cleaning solution;
at least one nozzle arranged to direct said cleaning solution onto at least a portion of the part disposed within said cleaning chamber; and
a valve adapted to selectively deliver said cleaning solution to said at least one nozzle.

22. The apparatus of claim 21 further comprising a sensor adapted to detect a presence of the part and to generate a control signal in response thereto, said valve being adapted to open in response to said control signal to selectively deliver said cleaning fluid to said at least one nozzle.

23. The apparatus of claim 21 further comprising a timer adapted to at least partially control operation of said valve to selectively deliver said cleaning solution to said at least one nozzle

24. The apparatus of claim 21 wherein said compressed fluid is air and said cleaning agent is an alcohol.

25. The apparatus of claim 24 wherein said cleaning agent is isopropyl alcohol.

26. An apparatus for cleaning a part, comprising:
a housing defining cleaning chamber;
means for mixing a compressed fluid and a cleaning agent to form a cleaning solution;
means for sensing a presence of the part; and
means for spraying said cleaning solution onto at least a portion of the part disposed within said cleaning chamber, said means for spraying being activated in response to said presence of the part within said cleaning chamber.

27. The apparatus of claim 26 further comprising means for regulating the duration of activation of said means for spraying.

28. The apparatus of claim 26 further comprising means for selectively supplying a regulated amount of said compressed fluid to said means for mixing.

29. The apparatus of claim 26 wherein said means for mixing includes means for adjusting an amount of said cleaning agent to be intermixed with said compressed fluid to form said cleaning solution.

30. The apparatus of claim 26 wherein said means for spraying includes:
at least one spray nozzle; and
means for adjusting a distance between said at least one spray nozzle and said at least a portion of the part disposed within said cleaning chamber.

31. A method of cleaning the probe tip of a coordinate measuring machine, comprising:
providing a housing defining cleaning chamber and at least one nozzle arranged to dispense a cleaning solution into said cleaning chamber;
positioning the probe tip within the cleaning chamber;
mixing a compressed fluid with a cleaning agent to form the cleaning solution;
detecting a presence of the probe tip within the cleaning chamber; and
dispensing the cleaning solution from the at least one nozzle and onto the probe tip in response to the detecting.

32. The method of claim 31 further comprising regulating the duration of the dispensing for a predetermined period of time.

33. The method of claim 31 further comprising providing a sensor for the detecting and a control valve for controlling the dispensing, the sensor generating a control signal in response to the presence of the probe tip within the cleaning chamber, the control valve selectively delivering the cleaning fluid to the at least one nozzle in response to the control signal.

34. The method of claim 31 wherein the nozzle is a spray nozzle, at least two spray nozzles being provided and arranged to spray the cleaning solution onto the probe tip from at least two different directions.

35. The method of claim 31 wherein the compressed fluid is air and the cleaning agent is isopropyl alcohol.

36. A method of cleaning the probe tip of a coordinate measuring machine, comprising:
providing a housing defining cleaning chamber, a cleaning agent contained within the cleaning chamber, and at least one nozzle adapted to dispense a fluid;
submerging the probe tip in the cleaning agent;
positioning the probe tip adjacent the at least one nozzle; and
dispensing the fluid from the at least one nozzle and onto the probe tip.

37. The method of claim 36 further comprising:
providing a sensor for detecting a presence of the probe tip within the cleaning chamber and a control valve for controlling the dispensing; and
the sensor generating a control signal in response to the presence of the probe tip within the cleaning chamber, the control valve selectively delivering the fluid to the at least one nozzle in response to the control signal.

38. The method of claim 36 wherein the nozzle is a spray nozzle, at least two spray nozzles being provided and arranged to spray the fluid onto the probe tip from at least two different directions.

39. The method of claim 36 wherein the dispensing facilitates evaporation of residual cleaning agent from the probe tip.

40. The method of claim 36 wherein the fluid is compressed air and the cleaning agent is isopropyl alcohol.
